(19) United States
(12) Patent Application Publication
(10) Pub. No.: US 2019/0242665 A1
(43) Pub. Date: Aug. 8, 2019

(54) METHOD FOR GENERATING AN ALARM IN CONNECTION WITH THE PRESENCE OF A SUBJECT IN A DANGER SPACE, COMMUNICATING DEVICE IMPLEMENTING THE METHOD AND ASSOCIATED SYSTEM

(71) Applicant: FIND TECH, Saint Victoret (FR)

(72) Inventors: Pierre ALLEYSSON, Saint Victoret (FR); Yannick ALMERAS, Coudoux (FR); Olivier ARGUIMBAU, Saint Maximin La Ste Baume (FR)

(73) Assignee: FIND TECH, Saint Victoret (FR)

(21) Appl. No.: 16/314,561

(22) PCT Filed: Jun. 23, 2017
(86) PCT No.: PCT/FR2017/051690

§ 371 Date: Dec. 31, 2018

(30) Foreign Application Priority Data
Jul. 1, 2016 (FR) 1656340

(51) Int. Cl. F41A 17/08; F41A 17/06; H04W 4/029; H04W 4/02; G08B 21/22

(52) U.S. Cl. CPC F41A 17/08; F41A 17/063; G08B 21/22; H04W 4/026; H04W 4/029

(57) ABSTRACT

The invention relates to a system of devices communicating with each other through a communication network. The invention relates in addition to a method, implemented by a first communicating device associated with a weapon, enabling an alarm to be generated in connection with the presence of a second communicating device in a danger space determined from the current position of the said first communicating device and the estimated direction of firing. Such a system is advantageously used to prevent hunting incidents in particular.

The invention relates to a system of devices communicating with each other via a wireless communication network. More specifically, the invention concerns a method implemented by a first communicating device conveyed by a first subject carrying a weapon, the said method enabling an alarm to be generated in connection with the presence of a second communicating device, itself worn by a second subject in a determined danger space, the said space being a three-dimensional space extending from the location of the first communicating device into the distance in a preferred direction, advantageously in the direction of firing.

As a non-restrictive example of a preferred application, the invention will be described by means of a system with multiple devices conveyed by subjects, who may be armed or associated with a weapon, for example a rifle or a bow. The said subjects may be the participants in a hunting party or more generally the hunters.

Hunting is a recreational activity that can be practiced in a group, for example during a driven hunt. The participants in a driven hunt are generally separated into two distinct groups, into beaters and shooters respectively. The beaters' mission is to drive the game towards the shooters, who are generally posted in determined positions.

Although hunting is a regulated practice, including and particularly from the point of view of safety, many accidents can occur. In effect, regulations recommend, for example, that the hunters wear a fluorescent orange garment so that they are easily visible and recognizable amongst the trees by other hunters. In addition, regulations generally dictate that firing carried out by a hunter is directed toward the ground so as to prevent ricochets that could strike a participant. In general, the said regulations also dictate clear signals alerting third parties, notably any walkers, that a hunting party is in progress. However, despite these regulations, many accidents can occur in “the heat of the moment.” As such, there may be accidents relating to equipment, for example, a projectile might damage a vehicle, or more seriously, accidents resulting in personal injury, i.e., when an individual, hunter or walker, is inadvertently struck by such a projectile. The notion of “individual” includes all participants in a hunting party, such as hunters, beaters, organizers, as well as any hunt animals, such as, for example, horses or dogs. As mentioned previously, the notion of “individual” also encompasses all third parties to the said hunting party, such as hikers, walkers or cyclists.

Studies have shown that a majority of hunting accidents occur by direct fire by hunters, with ricochet shootings representing only a small percentage of accidents. Furthermore, some personal injury accidents may prove fatal.

To better regulate the practice of hunting, many countries generally provide for an examination validating knowledge of the local regulations applied, and passing this examination results in the hunting permit being granted, for example. The number of fatal accidents can consequently be reduced when all of the participants in a hunting party have such a permit and apply the required recommendations. In addition, each hunting party generally begins with a reminder of the regulatory safety rules. To meet certain regulatory requirements, hunters can, for example, respectively wear jackets in bright colors, such as orange, or yellow safety jackets that are sometimes used at roadside in the event of a vehicle breakdown, or even clothing featuring reflective strips. This practice allows a participant in a hunting party to locate their partners or competitors when the latter are in the participant's field of view. However, when one of the said partners is located for example hidden, either intentionally or unintentionally, behind a row of bushes or a tree blocking the hunter's field of view, the latter may not know that such a partner is in their line of fire, and thus risks striking them.

In an attempt to better locate the participants in a hunting party, one method could be to transmit a regular audible signal, for example by means of a loudspeaker, in order to enable participants to locate their partners located nearby “by ear.” This method is, however, unsuitable for hunting parties requiring total silence, so as not to scare off the game or hunted animal. In addition, simultaneously and repetitively transmitting audible signals can disrupt or tire the hunter.

As a variant, a minimum safety distance between the participants in a hunting party may be required. This method, however, calls for a high degree of rigor and constant discipline from the hunters. However, this method only remains feasible on substantially flat ground with few trees. Yet many hunting grounds are steep and/or feature irregular terrain, or even include abundant vegetation, requiring participants to reduce their safety distances to move around, for example, a ravine or a space that is impracticable because of rocks or trees. Some hunting partners can thus leave a hunter's field of view and find themselves in danger, if the said hunter were to fire in the direction of the said partners who were not visible.

The invention is able to respond to all the disadvantages arising from the known solutions.

Later in the document, we will name as “subject” any equipment or individual carrying or cooperating with a communicating device that is according to the invention.

Among the many benefits that the invention offers, we can mention that a system according to the said invention allows a first communicating device, conveyed by a first subject carrying a weapon, to detect the presence of a second communicating device, conveyed by a second armed subject or simple walker, in a three-dimensional danger space, determined in particular by the direction of firing of the said first subject's weapon.

A communicating device according to the invention can in addition warn the said first subject of the presence of this second subject in the said space. The first subject can consequently change their direction of firing and/or decide not to fire, in order to avoid injuring the second subject. According to a variant of the invention, the second subject can in turn be warned of their presence in such a danger space, that is to say that a third party is pointing a weapon in their distinct direction. Such a warning may result, for example, from receiving and decoding an alert message transmitted by the first communicating device.

In addition and advantageously, the invention does not exclude knowing the respective positions of subjects conveying communicating devices according to the said invention. As such, depending on their positions, the organizer of a hunting party can order and impose the realignment of participants in order to restore the relevant safety distances and thus minimize the risk of accidents. Such an organizer can also redirect the movements of certain hunters so as to distance them from potential walkers, for example. However, the invention does not impose the centralization of localization information, according to which each participant would be equipped with equipment communicating with a remote server implementing a method of centralized risk management. This type of solution is restrictive, because it generally requires a long-distance or long-range communication type, for example a GPRS or satellite-based communication mode, and therefore has a particularly high energy consumption.

Furthermore, it makes the actors in the field dependent on a risk management policy which is centralized and sometimes faced with contradictory situations requiring generally human arbitration, to the detriment of reactivity and therefore effectiveness with regard to the prevention of accidents. On the contrary, the invention allows, in a decentralized manner, to equip for example each participant in a hunting party with equipment consuming little energy, because such equipment only communicates with peers near to each other and is configured to determine locally, that is to say individually, the probability of putting one of these peers at risk. Energy efficiency is thus increased, the loss of communication or localization minimized and the reactivity of such a system is increased tenfold compared to centralized management.

However, as we have discussed previously, the invention may additionally make it possible, at the level of each individual piece of equipment, to collect data capable of explaining the causes of a hunting accident or pedagogically increasing the awareness of participants in such a hunting party regarding safety rules for example. Such data may be consolidated if necessary as part of subsequent processing.

Finally, the invention helps give hunters and/or walkers a feeling of freedom and serenity, with these actors being correctly alerted to any firing that risks being dangerous to themselves or others.

For this purpose, in particular a method is intended to generate an alarm in connection with the presence of a subject in a danger space, with the said method being implemented by a processing unit of a first communicating device, with the said first communicating device being conveyed by a first subject carrying a weapon, and the said method enabling an alarm to be generated indicating the presence of a second communicating device conveyed by a second subject in a determined danger space, with the said processing unit cooperating with a human-machine output interface, means of storage and means of communication. The said processing unit also cooperates with means for determining the location of the said first communicating device and with means to assess the direction of firing of the said weapon. The means of storage include a localization structure comprising one or several records, respectively associated with one or more communicating devices, with each record configured to store localization data values of either the said first or second communicating devices. To determine the presence of the said second communicating device in the said danger area, the said method includes:
a step to collect localization data produced by the said means for determining the location of the said first communicating device;
a step to collect direction data produced by said means for assessing the direction of firing of the weapon associated with the first communicating device and estimating the said direction of firing of the weapon;
a step to estimate a danger space based on the estimated direction of firing, on localization data and on one or more determined parameters, with the said danger area extending from the current location of the said first communicating device into the distance in the said estimated direction of firing;
a step to read, from the localization memory, localization data of the second communicating device, stored in the record in the localization memory, with the content of the said record resulting from a prior step to:
   receive, via the means of communication, a localization message transmitted by the said second communicating device including localization data of the said second communicating device;
   extract from the said message the said localization data and save this data in the said record in the localization memory;
a step for testing the inclusion of the said localization data read in the estimated danger space;
a step to actuate the human-machine output interface, if the step for testing the inclusion of such localization data read in the danger space attests to such an inclusion.

To enable the identification of a communicating device present in a danger space initiated by the said first communicating device, each record in the localization structure may also contain a communicating device identifier associated with the localization data contained in the said record. To allow the second subject conveying the second device to be warned that they are located in a danger space, such a method may include, subsequent to the step for testing the inclusion of data localization within the danger space, if the said step attests to an inclusion:
a step to read from the localization structure and extract, from the record associated with the said localization data, the value of the communicating device identifier;
a step to generate an alert message including the said communicating device identifier extracted from the said record and to trigger the transmission of the alert message by the means of communication.

To log the events for the purposes of raising awareness or fault finding, the means of storage may include a report structure comprising one or more records each configured to store an update timestamp for the said record, a communicating device identifier and an event attribute. To update the said report structure, the said method may have a step subsequent to the step for testing the inclusion of localization data in the danger space, if the said step for testing the inclusion of such localization data in the danger space attests to an inclusion, for:
reading from the localization structure and extracting, from the record of the said structure associated with the said localization data, the value of the communicating device identifier;
storing in the report structure a record containing the respective values of the said extracted device identifier, an event attribute characterizing a danger, a timestamp characterizing the period of storing in the said report structure.

So that a third-party device can alert the first subject to their presence in a determined danger space, the said method may include:
a step to receive via the means of communication, an alert message with an event attribute conveying an alert and to decode the said message;
a step to actuate the human-machine output interface.

To log the presence of a third-party device in a danger space initiated by the direction of firing of the weapon associated with the first communicating device, the said method can include a step to store in the report structure a record with the respective values of an event attribute characterizing an alert and a timestamp characterizing the period of storing in the said report structure.

To download the history of events that occurred, the method may include a step to generate a report message containing all or part of the report structure and to trigger the transmission of the said message through the means of communication to a determined device.

To inform the communicating devices, located within communication range via the network, of the current location of the first communicating device, a method according to the invention may include a step subsequent to the step to collect localization data produced by the said first means of the said first communicating device, to generate a localization message including the said localization data of the said first communicating device and to trigger the transmission of the said localization message by the means of communication to any third-party communicating device located within communication range.

To determine the location of the said first communicating device, the means to determine the location of the said first communicating device may consist of a geolocation system.

To assess the direction of firing of the weapon associated with the first communicating device, implementing such a method according to the invention, the means to assess a direction of firing may advantageously consist of a compass or a magnetometer.

According to a second subject, the invention relates to a computer program product including program instructions which, when they are stored beforehand in a program memory of a communicating device associated with a weapon, the said communicating device including, besides the program memory, a processing unit, a data memory, means for determining the location of the said communicating device, means to assess the direction of firing of the said weapon, means of communication to ensure a determined communication mode and a human-machine output interface, the said interface, the said program and data memories, the said means to determine the location and to assess the direction of firing, in addition to the said means of communication cooperating with said processing unit, trigger the implementation by the said processing unit of a method to generate an alarm in connection with the presence of a subject in a determined danger space, according to the invention.

According to a third subject, the invention intends a communicating device including a processing unit, a program memory, a data memory, means for determining the location of the said communicating device, means to assess the direction of firing of a weapon associated with the said communicating device, means of communication ensuring a determined communication mode and a human-machine output interface, with the said communicating device including in its program memory instructions of a computer program product according to the invention.

According to a fourth subject, the invention relates to a weapon including or cooperating with a communicating device according to the invention.

According to a fifth subject, the invention relates to a system including or cooperating with at least one communicating device according to the invention and at least one weapon which is also according to the said invention.

Other characteristics and benefits will appear more clearly on reading the following description, relating to an example of implementation provided for informational purposes without being exhaustive, and on examining the accompanying figures, including:

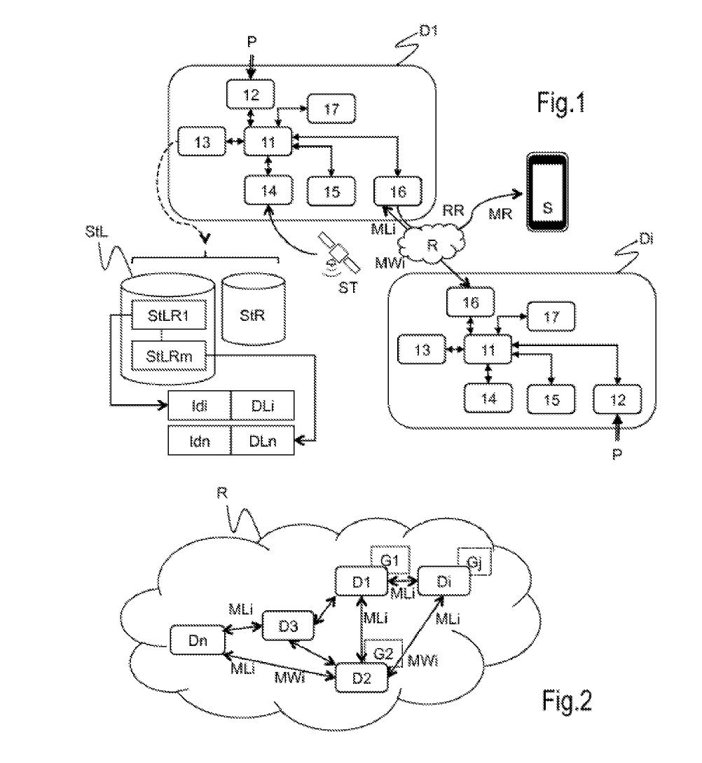

FIG. 1 describing an example of functional architecture of a system with two communicating devices according to the invention;

FIG. 2 presenting a simplified diagrammatic view of a system with multiple communicating devices according to the invention and communicating with each other via a communication network;

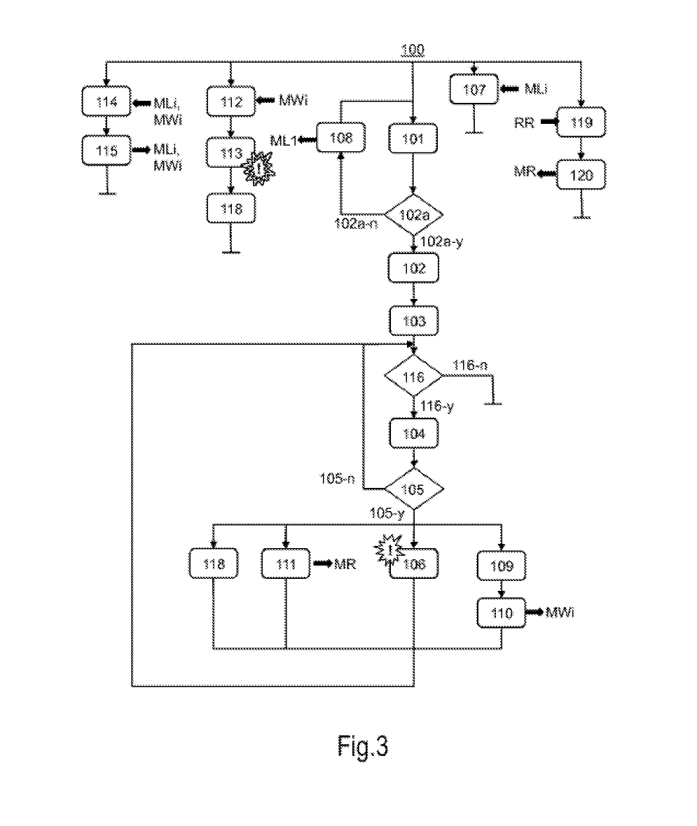

FIG. 3 presenting a functional process chart describing a method to generate an alarm in connection with the presence of a subject in a danger space according to the invention;

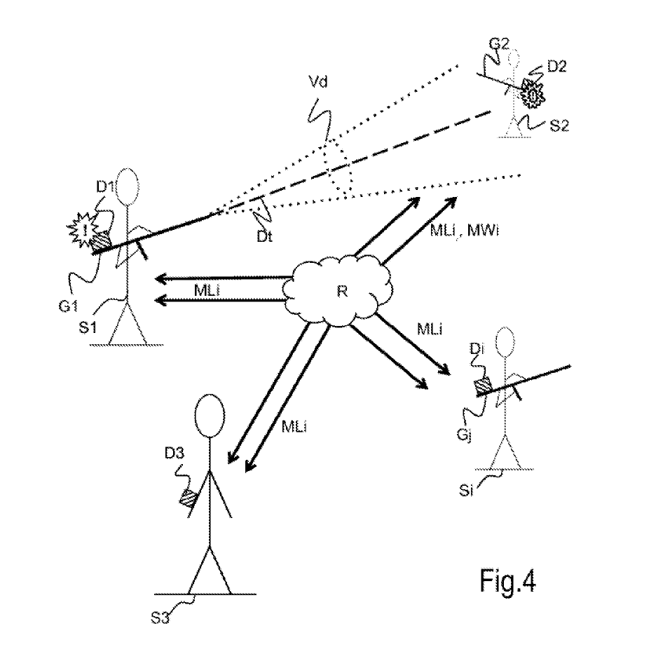

FIG. 4 illustrating an example of the simulation and use of a system according to the invention;

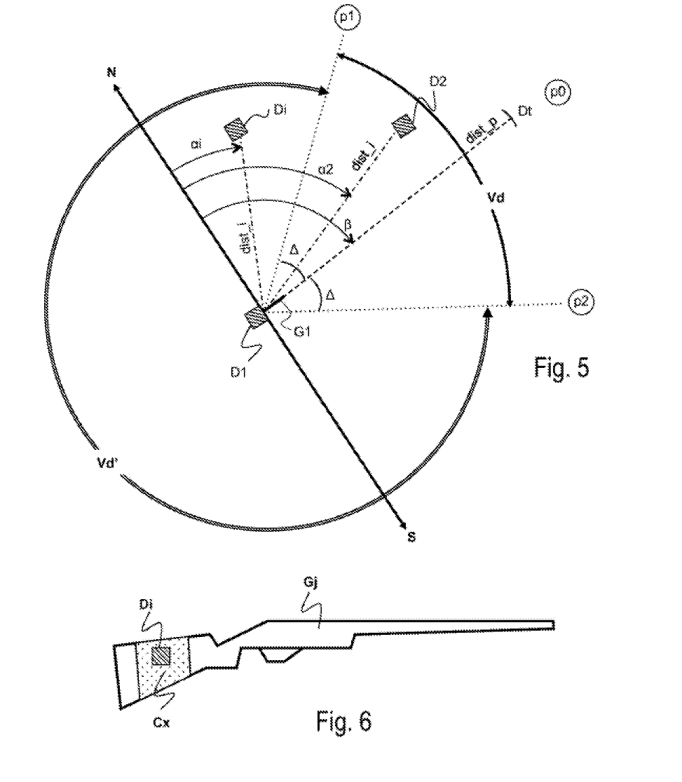

FIG. 5 presenting a simplified view of an example of using a method according to the invention to generate an alarm in connection with the presence of a subject in a determined danger space;

FIG. 6 illustrating an example of the adaptation of a weapon so that it cooperates with a device according to the invention, or more generally so that this weapon is associated with the said communicating device.

As an example of a preferred but non-restrictive application, the invention will be described by means of an application relating to the detection by a first communicating device, conveyed by a first subject, for example a hunter, carrying a weapon, such as a rifle, a bow or any other type of weapon, with the said first communicating device cooperating with said first communicating device, regarding the presence in a determined danger space of a second communicating device conveyed by a second subject, for example a walker or a second hunter.

FIG. 1 presents a system including multiple communicating devices, including two, referenced D1 and Di, communicating by means of a communication network R, advantageously wireless as shown in FIG. 2. The invention is not limited by a particular type of network used. Each communicating device Di is configured to implement a communication method allowing it to exchange messages with a nearby peer communicating device via the said network R. Such a network R can therefore consist of a “single-hop” communication network or “multi-hop” communication network. According to a simple-hop network, communication between a first communicating device and a second communicating device is direct. On the other hand, according to a multi-hop network, such communication may be indirect, i.e., a message can be relayed by third-party communicating devices in order to route the said message to its recipient.

Communication within such a network R can be advantageously implemented by a radio channel or radio waves, for example according to a protocol known as “Wi-Fi” or any other equivalent technology, ensuring wireless communications with a range of tens to hundreds of meters depending on the topology of the terrain. As a variant, although energy consumption would be higher, such communication could be implemented by GSM (“Global System for Mobile Communication”, GPRS (“General Packet Radio Service”) or any other appropriate wireless communication of greater range, if the communicating devices are intended to be relatively distant from each other.

According to FIG. 1, a communicating device D1 or Di includes means of localization 14 to determine the location of the said communicating device D1 or Di. Such means of localization 14 may consist of the first means of communication to “talk” with a satellite-based positioning and navigation system ST, for example the GPS system (“Global Positioning System”) or its improvement DGPS (“Differential Global Positioning System”). Such means of localization 14 cooperate with a processing unit 11 in the form of one or more microprocessors or microcontrollers. The processing unit 11 is in particular responsible for collecting the data transmitted by the satellite positioning system ST and received by the first means of communication 14. Such data may advantageously be encoded by the processing unit 11 to be transmitted to any other second device located within communication range within the network R in the form of a localization message MLi, as we will see later. To interact in this manner with a second such device, a communicating device according to the invention (D1 and/or Di according to FIG. 1) includes the second means of communication 16 which may consist for example of a modulator-demodulator. By means of the said second means of communication 16, a communicating device D1 or Di, or more precisely its processing unit 11, can trigger the transmission and/or detect the reception of messages sent to or received from third-party devices positioned within communication range. According to the invention, such messages may consist, in a non-restrictive manner, of MLi localization messages or MWi alert messages. According to a variant of the invention, the first and second means of communication 14 and 16 may consist of one and the same physical entity.

The processing unit 11 may advantageously include one or more microcontrollers or processors cooperating by coupling and/or by wire bus, represented by double arrows in FIG. 1, with the said means of localization 14 and said means of communication 16.

Advantageously but in a non-mandatory way, a device D1 or Di may additionally include means of storage cooperating by coupling and/or by wired bus with the processing unit 11. Such means of storage may consist of a program memory 12 configured to save in one or more programs P, or more generally one or more sets of program instructions, the said program instructions being intelligible to the processing unit 11. The execution or interpretation of the said instructions by the processing unit 11 results in the implementation of a method for the processing of data or the operating of the communicating device D1 or Di according to the invention, as we will explain later.

The means of storage may additionally include one or more data memories 13, as a non-restrictive example as suggested in FIG. 1 for the data memory 13 of the communicating device D1, in the form of a table with m records StLR1 to StLRm (m being an integer greater than or equal to 1) or a localization structure StL. Such a structure is mainly configured to save localization data DLi, DLn from one or more second third-party communicating devices, with the said DLi, DLn data resulting from MLi localization messages transmitted, in the form of a “broadcast” or multicast, and received by the means of communication 16. Such a reception conveys a proximity between the transmitting communicating device and the communicating device receiving the said MLi message.

In this particular case, in FIG. 1, the communicating device D1 receives an MLi localization message transmitted by the communicating device Di, the latter being within radio communication range of the said communicating device D1. The StL structure within the data memory 13 of the communicating device D1 allocates a record StLR1 to store in it the localization data of the communicating device Di deduced from the MLi localization message. In the same way, an m^{th} StLRm record can store the DLn localization data of an m^{th} communicating device located within the range of radio communication of the communicating device D1, in this particular case the nth communicating device of the system.

Such a data structure StL can advantageously be configured to save localization data transmitted by the GPS system respectively to the m communicating devices within radio communication range or generated from the said data.

The localization data DLi, for example in connection with the communicating device Di, may include, as an example, the latitude, longitude, and/or the altitude of the said communicating device Di, or even timestamp data characterizing the formulation of the said localization data DLi. Such localization data DLi could also include any other information characterizing, for example, the communication capacity of the said communicating device Di or more generally any attribute functionally or even structurally describing the said communicating device Di.

The data memory 13 is generally electrically erasable and writable. The data memory 13 may advantageously include a non-erasable section, which is physically isolated or simply configured so that access for writing or erasure is either prohibited or requires an authentication procedure to be completed. Such an advantageous section in the data memory 13, whose access for modification is restricted, makes it possible, in particular, to log in it a unique communicating device identifier, the value of which is specific to the latter. As such, an Idi identifier can be assigned to the communicating device Di and recorded in the data memory 13 of the said communicating device Di.

The data memory 13 of a communicating device according to the invention, such as the communicating device D1 or Di illustrated by FIG. 1, may also include any other data structure, called a report structure StR, for example in the form of a table intended to retrace a history of events associated with the said device D1 or Di in question. The said report structure StR may advantageously be secured to ensure the integrity of the data it contains, for example, by using a hash function or any other redundant code, in order to eliminate any risk of the said data being modified. Any other cryptographic solution may be used as a variant or supplement. Such security can also be supplemented by a physical locking mechanism, preventing any malicious access to the said StR memory.

According to a variant of the invention, the said means of storage 12, 13, as well as the different structures StL, StR of the data memory 13, may be physically separated or possibly form one and the same physical entity.

Advantageously, such a communicating device D1 or Di may have a battery or more generally any internal electrical power source from which to draw the necessary electrical energy for its operation. Such a communicating device D1 or Di may additionally include a clock allowing it to timestamp, as a non-restrictive example, the reception or the transmission of an alert message MWi or a localization message MLi.

A communicating device D1 or Di according to the invention may in addition advantageously include one or more human-machine interfaces for restitution or output 17 cooperating by coupling and/or by wired bus with the processing unit 11. The said human-machine interfaces for restitution 17 enable the restitution of a signal or perceptible information to be triggered by one of the five senses of the human conveying a danger, an alarm or an alert. As non-restrictive examples, such human-machine interfaces for restitution 17 may consist of a vibrator, a light emitting diode, a screen and/or a loudspeaker. The said human-machine interfaces for restitution 17 may be separated or possibly form one and the same physical entity.

As illustrated by FIGS. 2 (in a simplified manner) and 4 (in a detailed manner), a communicating device according to the invention may be associated or not with a weapon in order, for example, to be used during a hunting party by different subjects. Such a weapon may consist of a firearm or a bow. As a non-restrictive example, FIG. 6 shows a rifle Gj associated with a communicating device Dj. This device is advantageously attached to the butt of the said firearm Gj.

According to the example of the simulation shown by FIGS. 2 and 4, a first subject S1, for example a hunter, conveys a first communicating device D1 associated with a weapon G1, for example a rifle. The same applies to a second subject S2, conveying a second communicating device D2 associated with a second weapon G2, for example a bow. A third subject S3, for example a walker, is only conveying a communicating device D3. Such a third communicating device D3 is according to the invention and may be integrated into a garment of the said third subject S3. Another hunter Si conveys a communicating device Di according to the invention associated with a weapon Gj. Finally, a walker or instructor Sn, unarmed, only conveys a communicating device Dn. The said subject Sn is not represented on FIG. 4, because as FIG. 2 indicates, the said subject Sn is far from the scene illustrated by FIG. 4, with this scene being centered on the subject S1. The communicating device Dn is not, accordingly, within communication range of the communicating device D1.

When a communicating device D1 or Di, described in connection with FIG. 1, is associated with a weapon G1 or Gj, the said communicating device includes means 15 to assess or to estimate a direction of firing in connection with the said weapon G1 or Gj. The term “direction of firing” Dt refers to the direction of a theoretical trajectory potentially taken by a projectile projected by a considered weapon, in this particular case in FIG. 4, the weapon G1. The direction of firing Dt of such a weapon G1 may consist respectively of the direction of pointing or heading of a barrel if it is a firearm, or the direction of pointing or heading of an arrow if it is a bow. As a non-restrictive example, such a direction of firing can be symbolized in a simplified manner by a straight line Dt, as indicated in FIG. 4 by a dashed line.

The communicating device D1 then includes means 15 to assess a direction of firing Dt of the weapon G1. The said means 15 may consist, as non-restrictive examples, of a magnetometer, various compasses, an accelerometer and/or any other means to assess a direction of firing cooperating with the processing unit 11 of the device D1 and respectively producing data, which, taken jointly or separately, constitute the direction data allowing the direction of firing Dt of the weapon G1 to be assessed.

As FIG. 6 shows, as a non-restrictive example, such a device Di, in connection with a weapon Gj, can be inserted into a weapon Gj or be separate and simply cooperate with it. However, the said magnetometer, compasses and accelerometer are advantageously positioned on the weapon Gj, as a non-restrictive example, on the butt of the said firearm Gj. According to this latter variant, the device Di can then consist in a sleeve Cx or band to place on or around the said butt.

To emphasize the contribution of the invention, let us examine the case of use illustrated by FIG. 4, according to which a first device D1 in connection with a weapon G1 conveyed by a first subject S1 judges, through the implementation of an innovative method, such as the method 100 illustrated by FIG. 3, the presence of a second device D2 in connection with a weapon G2 conveyed by a second subject S2, in a danger space Vd determined by the said first communicating device D1.

Such a method 100 according to the invention and implemented by a processing unit 11 of the communicating device D1, described in connection with FIGS. 1 and 4, includes a first step 101 to collect localization data DL1 describing its position within the space. The said step 101 may involve requesting from the means of localization 14 the terrestrial positioning of the said device D1, as a non-restrictive example, by formulating and encoding a localization request with an Id1 device identifier and an attribute characterizing the said request to a geolocation system, such as, for example, a GPS system. The device D1 may consequently receive and decode a message from the said geolocation system including localization data DL for the said device D1. Such localization data DL may, as non-restrictive examples, consist of one or more values conveying the longitude, latitude, and/or altitude of the said device D1. The localization data DL decoded in this manner can then be stored in the data memory 13, within a structure specifically dedicated to this use or by creating a record in the data table StL examined previously, including one of the records StLR1 to StLRm. For example, the first of these is reserved for the current positioning of the communicating device, as opposed to other records which are reserved for saving the localization data DLi of third-party communicating devices located within radio communication range. According to the second embodiment, the data memory 13 of communicating device D1 may include a localization data structure StL where one of the records StLR1 to StLRm is dedicated to the communicating device D1 for saving the current localization data DL1. Such a data structure StL may also contain metadata related to the communicating device D1, such as for example, a timestamp for the transmission of the said localization request and/or update of the said structure StL by the processing unit 11. Such a step 101 can be implemented periodically, as a non-restrictive example, every second.

The method 100 may include a step 102a to determine if the weapon G1, associated with the communicating device D1 whose processing unit 11 implements the said method 100, is in a firing situation or firing capacity, for example by making use of one or more sensors cooperating with the said processing unit 11 or communicating through a wired or wireless communication network with the said communicating device D1. The said sensor(s) detect the presence of a finger close to a trigger, detect the presence of ammunition, etc. When the said step 102a attests that the weapon G1 is in a firing situation, symbolized by the link 102a-y in FIG. 3, the method 100 includes a step 102 to collect direction data and estimate a direction of firing Dt. If not, a situation symbolized by the link 102a-n in connection with FIG. 3, the method 100 is interrupted. The said step 102 involves requesting from the means 15 to assess a direction of firing Dt, the acquisition of data which, jointly or separately, constitute direction data. As a non-restrictive example, the said means 15 may consist of a magnetometer. The said data collected may consist of the intensity value of the magnetic field at the terrestrial location of the device D1. As FIG. 5 indicates, this measure can be used to estimate an angle β formed between the reference axis of the magnetometer, for example the North-South magnetic or geographical axis, represented in FIG. 5 by a double arrow NS, and the said direction of firing Dt. The angle β may consist, for example, of the azimuth, i.e. the angle on the horizontal plane of the direction of the weapon G1 and the North-South geographical axis, considered as the direction of reference. The angle β can be estimated by the processing unit 11 of the device D1 or even within the said magnetometer and be output or delivered to the said processing unit 11.

To estimate the presence or absence of a third-party device D2, and therefore of a subject, in this particular case the subject S2 in FIG. 5, in a danger space Vd, i.e., distinctly in the line of fire of the weapon G1 associated with the device D1 conveyed by the subject S1, the said device D1 implements a method 100 including a step 103 to estimate the said danger space Vd, as indicated in FIG. 3. The said step 103 may involve estimating a three-dimensional space from the localization data DL1 of the device D1, of the direction of firing Dt and determined parameters, such as, by way of non-restrictive examples, two relative angles +Δ and −Δ in relation to the direction of firing Dt characterizing the danger space Vd, as represented in FIG. 5. The latter, in this case, can be considered as a section or slice of a sphere of which the center is determined by the localization data DL1 and whose radius is determined or infinite, forming an angle equal to 2Δ whose direction of firing Dt would be the bisector.

Such a danger space Vd extends from the location of the device D1, determined from localization data DL1, into the distance, as described in a simplified way in FIG. 5. It may symbolically be expressed as “everything that is in front of the shooter.”

According to a variant or a supplement, it is also possible to limit the vertical or longitudinal opening of such a danger space by a determined parameter ψ, not represented on FIG. 5. As such, a communicating device according to the invention may estimate that the risk of injury to a hunting partner or a third party is reduced, or even eliminated, as soon as the direction of firing becomes relatively vertical, toward the ground or toward the sky, thus limiting the said danger space.

The parameter Δ can be predetermined or modifiable. It may, for example, be recorded in the data memory 13. The value of such a parameter can also be determined by the user, the organizer, or even the subject intended to convey the communicating device, in this particular case for example the subject S1 in FIG. 5, as we will see later.

For a driven hunt or for a firing exercise, the danger space Vd′ can be a space complementary to the danger space Vd previously described and illustrated by FIG. 5. Indeed, during a firing exercise for which the shooters are in fixed positions or during a driven hunt where the shooters move forward, substantially aligned on a straight line perpendicular to the direction of travel, a shot significantly into the distance from a firing position or toward the horizon in the field of view of the shooter does not incur a risk, because the site can be secured. On the other hand, it becomes important to alert, or even to prevent any firing, as soon as a weapon is pointed away from the firing position or expected movement of the driven hunt, i.e. once moving out of the illustrated space Vd shown in FIG. 5 to enter a danger space, in the form of an angular sector Vd′ complementary to the said angular sector Vd. The choice of judging a danger space that we can term as “direct,” i.e. on both sides of the line of fire Dt, such as the space Vd shown in FIG. 5, or a danger area that we term as “complementary” Vd′, that is to say everything except the direct angular sector Vd illustrated in FIG. 5, can be parameterized by the user via an appropriate human-machine interface or by an organizer. In connection with FIG. 5, such a danger space Vd′, in the form of an angular sector, could be calculated as Vd′=360°−2Δ, for which the bisector would be the line of fire Dt. Such a “complementary” danger space Vd′ is represented by an arc with double lines on FIG. 5, contrary to the “direct” danger space Vd, represented with a full-thickness line on the said FIG. 5. The invention intends an intelligent way to adjust the value of the parameter Δ. Such an adjustment method, implemented by the processing unit 11 of a device communicating according to the invention, will be described later.

Let us resume the description of a method 100 according to the invention and for which a non-restrictive example is illustrated by FIG. 3. Once a danger space Vd or Vd′ has been judged in step 103, the said method 100 includes a step 104 to read and extract the localization structure StL, from location data DL2 of a first record associated with a first third-party communicating device D2, localization data resulting from the decoding of a localization message MLi first transmitted by the said third-party communicating device D2.

A step 105 now involves testing the inclusion of the said localization data DL2 in the danger space previously defined. Let us take the case of a “direct Vd” danger space. As a non-restrictive example, such a step 105 may include a first sub-step to estimate a distance dist_i between the device D1 implementing the method 100 and the third-party device D2, in order to exclude the said third-party device D2 from the said danger area, if the latter is located outside the range of the projectile of the weapon G1. In this case, the danger space Vd is bounded by a maximum distance dist_p. In a variant, such a predetermined filter may not be implemented, considering that one does not wish to limit the firing range of the weapons considered. The calculation of the distance dist_i separating the device D1 from the third-party device D2 can be performed by the processing unit 11 of the said device D1, for example by using the localization data DL1 and DL2 respectively associated in the data memory 13 to devices D1 and D2 and by applying a formula known as “the haversine formula,” allowing the distance between two points on a sphere to be determined from their respective latitudes and longitudes. In cases where the danger space is bounded, the first sub-step of step 105 may therefore involve comparing the said estimated distance dist_i with a predetermined value dist_p stored in the data memory 13 of the device D1. If the value of the estimated distance dist_i is greater than the predetermined distance dist_p, the communicating device D2 is considered to be located outside of any danger space, because too geographically distant from the communicating device D1, taking into account the specificities of the associated weapon G1 or the ammunition used. In the contrary case, that is to say if the value of the estimated distance dist_i separating the communicating device D1 from communicating device D2 is less than the predetermined distance dist_p, the subject S2 conveying the said communicating device D2 may be in danger. Step 105 may then include a second sub-step to estimate an angle α2 corresponding to the azimuth angle of the third-party device D2 in relation to the North-South reference axis, as represented in FIG. 5. The sub-step 105-b is to subtract the angle α2 from the previously determined angle β. According to a first situation, if the result obtained is lower in absolute value than the angle Δ, then the step 105 attests to the inclusion of the third-party device Di within the danger space Vd created by the communicating device D1, this situation being symbolized by the link 105-y in FIG. 3. According to a second situation, if the result obtained is higher in absolute value than angle Δ, the step 105 attests to the exclusion of the third-party device from the danger area Vd, this situation being symbolized by the link 105-n in FIG. 3. As such, as described in the example in FIG. 5, the device Di is not in danger, because the absolute value resulting from the subtraction of the angle αi from the angle β is greater than the angle Δ, which is equivalent mathematically to |β−αi>Δ. On the other hand, the communicating device D2 is considered to be included in the said danger area Vd, because the absolute value of the subtraction of the angle αi from the angle β is less than the angle Δ, which is equivalent mathematically to |β−αi|<Δ.

If a “complementary” danger space such as the space Vd′ had been chosen, the step 105 would involve implementing a test, not of the type “|β−αi|<Δ?”, but of the type “|β−αi|<Δ?”. In this case, still in connection with FIG. 5, the communicating device D2 would not have been regarded as being in danger, unlike the communicating device Di.

The method 100 can contain as many iterations of step 105 as there are records in the data structure StL, as the test 116 in FIG. 3 indicates. If such a second record exists, then the said method 100 includes a step 104 to read the localization data DLi of a second record specifically for a second third-party device Di, and so on, as long as there is a record in the data memory 13 associated with a third-party device, this situation being symbolized by the link 116-y in FIG. 3.

On each reading 104, an iteration of the step 105 is implemented.

Once one iteration of the said step 105 attests to the inclusion of a communicating device D2 or Di in the danger space Vd or Vd′ of the communicating device D1, a method 100 according to the invention implements a step 106 to actuate the human-machine output interface 17 of the device D1 in order to warn the subject S1 conveying the said device D1 of a danger. Such a step 106 may be to generate a command for actuation of the human-machine output interface 17 involving, as a non-restrictive example, an event attribute characterizing a particular danger, and to transmit the said command to the said human-machine output interface 17. As non-restrictive examples, such a human-machine output interface 17 may consist of a light emitting diode and/or of vibrating means. The command thus transmitted can consequently trigger the flashing of the said diode, as a non-restrictive example, with a frequency of fifty Hertz, or a vibration characteristic of the said vibrating means.

The invention would not be limited to this single example for implementing a method to generate an alarm in connection with the presence of a subject in a danger space. All other test methods and calculations could, in a variant or supplement, be implemented, particularly, as a non-restrictive example, in the previously studied steps 102a, 102, 103, 116, 104, 105 and 106.

As a supplement, the invention provides, when the step 105 attests to the presence of a third-party communicating device D2 or Di in the danger space Vd or Vd′ of the communicating device D1, that a method 100 can have a step 109 to read and extract from the record in the localization structure StL associated with the said third-party device D2 or Di, the identifier of the communicating device in question, in this particular case the value of the Idi identifier for the communicating device Di. A step 110 may then consist of formulating an alert message MWi to be sent to the said device Di and trigger the transmission of the said message MWi generated by the means of communication 16 of the communicating device D1. Such an alert message MWi advantageously includes an event attribute conveying an alert and the previously extracted Idi device identifier. The said message MWi is routed to the said third-party device Di across the network R, possibly, if the network allows, in a relayed manner, that is to say, by one or more third-party communicating devices located within communication range. In addition to the alert discouraging the subject D1 from firing, the walker or a hunting partner can then be alerted to their inclusion within a danger space.

As such, so that the communicating device D1 can in turn be informed of its own inclusion in a determined danger space by a third-party communicating device, a method 100 according to the invention and implemented by the said communicating device D1 may include a step 112 to receive, via the means of communication 16, an alert message MW1, with the said message MWi containing an event attribute conveying an alert and the value of the identifier of a device receiving the message MWi and possibly the value of the identifier of the device transmitting the said message MWi. The said step 112 also involves decoding the said message MWi.

The method 100 can then implement a step 113 to generate an alert command to be sent to the human-machine output interface 17 of the communicating device D1 to activate it. Such an alert command may include an event attribute which can be interpreted by the said human-machine interface 17 and conveying or characterizing a particular alert, i.e. conveying a dangerous situation or the exposure to danger for the subject S1 conveying the communicating device D1, implementing the said method 100, and according to which the said subject S1 conveying the device D1 would be informed that he is, in turn, included in a danger space initiated by the direction of firing of a weapon carried by a third party, for example a weapon Gj carried by the subject S1 and associated with the communicating device Di described in FIG. 4. As non-restrictive examples, the said alert command may trigger the flashing of a light-emitting diode according to a frequency different from that triggered by an alarm activated in step 106 of the method 100, for example at a frequency of twenty-five Hertz, or trigger any other means capable of visually, audibly and/or kinesthetically alerting the user S1 of the communicating device D1. Such a human-machine output interface 17, so as to trigger an alert signal of being at risk from others, may additionally consist of a second human-machine output interface, distinct from that actuated to output a signal of alarm or risk from others activated in step 106 of the method 100. It may, in a variant, include a third-party device cooperating with the processing unit 11 by wire or wirelessly. For example, such a second human-machine output interface may consist of a headset in communication with the processing unit according to a wireless communication protocol, as defined by the Bluetooth standard or any equivalent protocol.

To determine the value of the parameter Δ, for example, by a user such as the organizer of a hunting party or by the subject S1 conveying the communicating device D1 according to the invention and illustrated by FIG. 5, a method to generate an alarm in connection with the presence of a subject in a danger space may thus include one or more additional steps not described in the example of the method 100 shown in FIG. 3.

A first step may be to detect a first actuation by the subject S1 of a human-machine input interface, such as a push button for example, wired or wireless communication with the processing unit 11 of the communicating device D1, when the latter is according to the example of implementation shown in FIG. 1. Prior to this first actuation, the subject S1 will have positioned their weapon G1 in a direction of firing Dt which is substantially static and horizontal, and in front of him in the distance will be p0 or a reference post or pole correctly positioned in view of the current positioning of the subject S1. The said first actuation of the said human-machine input interface results in the storing, for example in the data memory 13 of the said device D1, of a first set of data issued by the means 15 to assess a direction of firing Dt of the weapon G1; the said means 15 may consist, as non-restrictive examples, of a magnetometer, various compasses, an accelerometer and/or any other means to assess a direction of firing cooperating with the processing unit 11 of the device D1 and respectively producing data, which, taken jointly or separately, constitute the direction data DD allowing the direction of firing Dt of the weapon G1 to be assessed.

The subject S1 can now aim their weapon G1 in the direction of a second point on the horizon p1 or a second reference post or pole and actuate a second time the human-machine input interface. For this, the subject S1 performs with his weapon G1 a rotation, advantageously to his left, in a substantially horizontal plane. A method to generate an alarm in connection with the presence of a subject in a danger space may thus include a second additional step to detect such a second actuation of the human-machine input interface and record, in the data memory, a second set of data transmitted by the means 15 to assess a direction of firing Dt of the weapon G1.

The subject S1 can now aim their weapon G1 in the direction of a third point on the horizon p3 or a third reference post or pole and actuate a third time the human-machine input interface. For this, the subject S1 performs with their weapon G1 a rotation in a substantially horizontal plane, to their right according to the example described in FIG. 5. A method to generate an alarm in connection with the presence of a subject in a danger space may thus include a third additional step to detect such a third actuation and store a third set of data issued by the means 15 to assess a direction of firing Dt of the weapon G1.

A fourth step can then consist, based on the three sets of data stored and issued by the means 15, of estimating the value of the parameter Δ, since two times the value of this angle defines an angular sector described by the direction of firing Dt between the last two successive actuations of the human-machine input interface. The estimated value of Δ or 2Δ is recorded as a parameter, for example in the data memory 13. Such a configuration can be the subject of four new steps in the method 100 for generating an alarm in connection with the presence of a subject in a danger space or can be the subject of a configuration method separate from the latter.

In a variant, such a configuration method may only contain the three latest steps mentioned previously to determine A, with the application of the direction of firing at point p0 possibly optional.

To increase the awareness of participants in a hunting party or to constitute a basis for diagnosis or investigation following a hunting accident, the invention provides that each communicating device according to the said invention may automatically constitute its own history of events during the said hunting party. For this, as mentioned in connection with FIG. 1, such a communicating device D1 or Di contains a report structure StR within the data memory 13 cooperating with the processing unit 11, with the said processing unit implementing a method 100 according to the invention. In this case, such a method 100 can have a step 118 to store, within a record of the said report structure StR of the data memory 13 of the said device D1, one or more event attributes characterizing, for example, the detection of a third-party communicating device Di, and therefore of a subject S1 potentially at risk, included in a danger space Vd initiated by the direction of firing of the weapon G1 associated with the communicating device D1. Such a step 118 may additionally record in a record in the data structure StR the date and time of the reception of an alert message MWi, as well as supplementary elements, for example the identifier of the communicating device Di having transmitted the said alert message.

In connection with FIGS. 4 and 5, during the detection, in step 105 of the method 100, a communicating device D2 or Di in the danger space Vd estimated by the communicating device D1, the step 118 may consist of storing, in a record in the report structure StR, an event attribute characterizing posing a danger to others, a timestamp of the said detection and the Idi identifier of the communicating device detected in the danger space. The identifier of the said communicating device conveyed by a threatened subject may have been previously searched for and read from a record associated with localization data DLi in the localization structure StL.

According to a second example, when receiving an alert message MWi in step 112 of the method 100, step 118 may consist of storing an event attribute characterizing an alert of being at risk from others, a timestamp of the reception of the said message MWi and the Idi identifier of the communicating device transmitting the said message MWi.

As such, each risk of putting others in danger or being at risk from others detected by a communicating device according to the invention is timestamped, thus making it possible to reconstruct the behavior and the path of the subject conveying the said communicating device.

To compile such a history, a method 100 according to the invention may in addition include a step 111 to generate a report message MR and to trigger the transmission of the said message MR to a third-party backup device S, such as a server or a smart tablet, across the communication network R. Such a report message MR includes all or part of the report structure StR and the identifier of the transmitting device, for example the communicating device D1 described in FIG. 1. In a variant, the contents of the said history can be read via the said message MR, in response to the reception of a request RR transmitted from the said third-party device S, if and only if the latter meets the cryptographic conditions authorizing such a reading. Such a situation is respectively represented in FIG. 3 by the steps 119 and 120. Such a history can be used following a hunting incident to understand the cause of the said incident or for educational purposes for an instructor.

According to a variant, the content of the records of the report structure StR can be simplified in order to contain only the value of the event attribute characterizing the said event.

To not affect the preventative effect provided by the invention due to a hunting ground with irregular terrain, dense trees, rocks, or any other obstacles likely to strain a wireless communication range via the network R between different communicating devices according to the invention, the said communication network R can be advantageously adapted to be a “multi-hop” network. The method 100, implemented by the different devices D1, D2, D3, Di, Dn, communicating through such a network R, can be adapted so that, when receiving a message, for example an alert message MWi, the said method 100 includes a step 114 to decode the Idi identifier of the communicating device receiving the said message and compare the said Idi identifier value decoded at the value of its own identifier. If the values of identifiers coincide, then the processing unit 11 of the device having received the said MWi message decodes the rest of the message and implements the steps of the method 100 as previously examined. On the other hand, if the values of the identifiers are different, then the said method 100 may include a step 115 to relay the said message MWi to the third-party devices located within communication range via the network R. Such a step 115 may involve triggering the retransmission of the said message MWi by the means of communication 16, with the said MWi message possibly supplemented or enriched by the addition of the identifier value of the relaying device. The invention provides that such an option for repeating an alert message MWi may be extended to any message from a communicating device sent to one of its peers, including localization messages MLi. In this case, all messages MLi received may be relayed in an indiscriminate manner, thus increasing the probability that a communicating device is aware of the locations of the greatest number of nearby communicating devices, even though some are not within direct radio communication range.

To update the localization structure of StL in a data memory 13 of a communicating device according to the invention, such as the communicating device D1 described in connection with FIG. 1, a method 100 for generating an alarm in connection with the presence of a subject in a danger space, with the said method being implemented by the processing unit 11 of the said communicating device D1, can include a step 107 to receive, through the means of communication 16, a localization message MLi transmitted by a peer device Di, the said message including localization data DLi of the said third-party communicating device Di, or even, advantageously but not necessarily, the Idi device identifier of the said third-party device Di. Step 107 may consist then of saving, in a record in the localization structure StL of the device D1, the said localization data DLi, or even the said Idi identifier, if the latter has been transmitted. Such a step 107 may also involve storing a timestamp of such an update of the memory 13, or even any other supplementary data optionally conveyed in the said localization message MLi.

In order to increase efficiency by having in the StL structure only StLR1, StLRm records associated with communicating devices which are potentially in danger depending on the direction of firing Dt of a weapon, a method for generating an alarm in connection with the presence of a subject in a danger space 100 according to the invention may also include a step to estimate the “exit” of a third-party device Di from the monitored or potentially accident-prone environment linked to the weapon G1 associated with the communicating device D1 and thus potentially eliminate localization information DLi that have become irrelevant or obsolete in the localization structure StL. The term “monitored or potentially accident-prone environment” refers to a space centered around the current location of the communicating device D1, as a non-restrictive example, a sphere of a predetermined radius corresponding to the maximum distance dist_p that a projectile projected by the weapon G1 can follow, as discussed previously, plus a multiplication factor greater than or equal to 1 or any other predetermined value. All localization data DLi inducing a distance greater than the distance dist_p plus multiplication factor can be deleted.

Such a step, not described in the example shown in FIG. 3 and aimed at optimizing the content of the structure StL, may also involve comparing two successive units of localization data DLi(t) and DLi(t+1) of a third-party device Di, where t and t+1 are attributes that characterize the successive timestamps for the reception of localization messages MLi containing the said localization data DLi(t) and DLi(t+1). Such a comparison consequently enables a physical exit of the subject S1 conveying the said device Di to be estimated. One such variant implies that a record St1R1 is configured to store at least two occurrences DLi(t) and DLi(t+1) of localization data DLi of a same communicating device Di. A comparison of the said localization data DLi(t) and DLi(t+1) conveying distance or movement sufficient to no longer be endangered by the device Di in regard to communicating device D1 can be exploited by the latter to delete the content of the said record associated with the said Di device within the structure StL.

As a variant or a supplement, a method 100 for generating an alarm in connection with the presence of a subject in a danger space according to the invention may be adapted so that step 107 triggers the erasure of one or more records StLR1 to StLRm from the localization structure StL, if the said records have not been updated for a predetermined period of time, for example an hour. Such a situation can, for example, be the result of the increased physical distance of the subject conveying a communicating device, preventing the latter from being within radio communication range.

A communicating device according to the invention, for example the communicating device D1 shown in FIG. 1, 2, or 4, whether it cooperates or not with a weapon, may inform any other third-party device Di of its current location, to avoid in turn being an unintentional target of the subject S1 conveying the said communicating device Di. A hunter can in effect be included in turn in a danger space initiated by the direction of firing of another hunter. For this purpose, the method 100 may include a step 108 to generate and trigger the transmission, by the means of communication 16 via network R, of a localization message MLi sent to any third-party device in the said network R positioned within communication range. The said message MLi contains or encodes the current localization data of the said communicating device D1 whose processing unit 11 implements the said method 100, for which a preferred example is illustrated by FIG. 3, or even the identifier of the said communicating device D1. The said localization data will thus enrich an StL structure recorded in the data memory 13 of a peer communicating device Di. Step 108 may consequently involve, prior to formulating the localization message, searching in the localization structure StL for the record dedicated to the device D1 and extracting from it the values of current location data for this device. Such a localization message may advantageously be transmitted via the means of communication by the processing unit 11 in “broadcast” mode, i.e. to any device located within communication range. As such, any device capable of receiving and decoding such a localization message can be aware of the location of the communicating device D1. The steps 101 and 108 can be regularly implemented every second, for example, or on the basis of any other determined intervals.

A device Di according to the invention may not necessarily be associated with a weapon Gj according to certain embodiments. As such, it can be expected that there are devices Di which do not have all the features previously referred to, and which only implement some steps of the method for generating an alarm in connection with the presence of a subject in a danger space, of which a non-restrictive example in the form of a method 100 has been shown in FIG. 3. As such, it would be possible to implement in such a communicating device, such as the device D3 shown in FIG. 5, a method 100 which would not include the steps 102 to 106, 109 or 110, for example, because such a communicating device according to the invention is intended to equip a walker S3.

1. A method for generating an alarm in connection with the presence of a subject in a danger space, the method being implemented by a processing unit of a first communicating device, the first device being conveyed by a first subject carrying a weapon, the method indicating the presence of a second communicating device conveyed by a second subject in a determined danger space with the processing unit cooperating with a human-machine output interface, memory, and a communication interface, wherein:
the processing unit is configured to determine a localization of the first communicating device and to determine a direction of firing of the weapon; and
the memory stores a localization structure including a record associated with the second communicating device conveyed by the second subject, with the said record being configured to store values of localization data for the second communicating device;
and wherein the method comprises:
obtaining localization data representing a location of the first communicating device;
obtaining direction data to estimate the direction of firing of the weapon carried by the first subject conveying the first communicating device;
obtaining a first virtual reference point based upon a first user input while the weapon is aimed in a first direction of firing;
obtaining a second virtual reference point based upon a second user input while the weapon is aimed in a second direction of firing horizontally displaced from the first direction of firing;
estimating a danger space based on the obtained localization data and on the first and second virtual reference points, the danger space extending from the current location of the first communicating device into the distance according to the estimated direction of firing;
receiving, via the communication interface, a localization message transmitted by the second communicating device containing localization data of the second communicating device;
extracting from said message the said localization data and storing said data in the record in the memory;
reading the localization data of the second communicating device stored in the record of the memory;
testing whether the localization data read from the memory is included in the estimated danger space; and
actuating the human-machine output interface if the step for testing attests to such inclusion of the read localization data in the estimated danger space.

2. The method according to claim 1, wherein:
a record in the localization structure additionally includes a communicating device identifier associated with localization data contained in the record;
the method includes, if the step for testing the inclusion of the localization data in the danger space attests to an inclusion:
a step to read from the localization structure and extract, from the record associated with the said localization data, the value of the device identifier; and
a step to generate an alert message including the device identifier extracted from the said record and to trigger the transmission of the alert message by the means of communication interface.

3. The method according to claim 1, wherein:
each record in the localization structure additionally includes a device identifier associated with localization data contained in the record;
the memory contains in addition a report structure comprising one or more records, each configured to store a timestamp for the update of the said record, a device identifier and an event attribute;
and further including a step posterior to the step for testing the inclusion of localization data in the danger space, if the said step to test the inclusion of such data in localization in the danger space attests to an inclusion, to:
read from the localization structure and extract, from the record of the structure associated with the localization data, the value of the device identifier; and
store in the report structure a record with the respective values of the extracted device identifier, of an event attribute characterizing a danger, with a timestamp characterizing the period of storing in the said report structure.

4. The method according to claim 1, comprising:
a step to receive, via the communication interface, a warning message containing an event attribute conveying an alert and decode the message; and
a step to actuate the human-machine output interface.

5. The method according to claim 3, wherein the method includes a step to store in the report structure a record with the respective values of an event attribute characterizing an alert and a timestamp characterizing the period of storing in the report structure.

6. The method according to claim 3, wherein the method involves a step for formulating a report message including all or part of the report structure and to trigger the transmission of the message via the communication interface to a determined device.

7. The method according to claim 1 with a step to collect localization data produced by the processor of the first communicating device, to generate a localization message containing such localization data of the communicating device and to trigger the transmission of the message by the communication interface to any second communicating device located within communication range.

8. The method according to claim 1, wherein the determination of the location of the first communicating device is performed with reference to a geolocation system.

9. The method according to claim 1, wherein the direction of firing is determined with reference to a compass or a magnetometer.

10. A program memory of a communicating device encoded with program instructions which, when they are executed by a processing unit of the communicating device, cause said processing unit to implement a method to generate an alarm in connection with the presence of a subject in a danger space according to claim 1.

11. Communicating device containing a processing unit, a program memory, a data memory, a communication interface ensuring a determined communication mode, and a human-machine output interface, said device having in its program memory instructions of a program according to claim 10.

12. A weapon in combination with a device according claim 11.

13. A system including at least one device according to claim 11 and at least one weapon associated with said device.
